(19) United States
(12) Patent Application Publication
(10) Pub. No.: US 2024/0086781 A1
(43) Pub. Date: Mar. 14, 2024

(54) A METHOD FOR MODIFYING BOOKING DATA FOR A SHIPPING SYSTEM AND RELATED ELECTRONIC DEVICE

(71) Applicant: MAERSK A/S, Copenhagen K (DK)

(72) Inventors: Abhishek SANWALIYA, Bangalore (IN); Sunil Kumar CHINNAMGARI, Bangalore (IN); Vaibhav Shivaji JADHAV, Sangli (IN)

(21) Appl. No.: 18/262,084

(22) PCT Filed: Jan. 28, 2022
(86) PCT No.: PCT/EP2022/052048

§ 371 Date: Jul. 19, 2023

(30) Foreign Application Priority Data
Jan. 29, 2021 (DK) PA202170044

(51) Int. Cl. G06Q 10/02; G06F 40/284; G06F 40/30; G06Q 10/083

(52) U.S. Cl. CPC G06Q 10/02; G06F 40/284; G06F 40/30; G06Q 10/083

(57) ABSTRACT

Disclosed is a method, performed by an electronic device, for modifying booking data for a shipping system. The method comprises obtaining a text data set. The method comprises determining, based on the text data set and an entity extraction model, a modification set comprising an entity parameter and a first modification parameter. The first modification parameter is associated with a first confidence parameter. The method comprises outputting, based on the modification set, a modification output for modifying the booking.

The present disclosure pertains to the field of transport and freight. The present disclosure relates to a method for modifying booking data associated with a booking for a shipping system and related electronic device.

### BACKGROUND

Booking modifications, such as booking amendments, are part of the useful services offered to customers. Customers may want a shipper to prioritise a shipment and may wish the shipper to be updated at the earliest. Any delay in handling the booking modification not only impacts the customer satisfaction, but also leads to obstacles such as pending queues to be processed by resources, and possible delay in settlement.

Booking modification needs specialization and speed. Booking modification are also vulnerable to human subjectivity in processing booking modification requests.

### SUMMARY

Booking modification requests are repetitive, however resolving them involves a complex set of rules with numerous validations. There is a need for supporting the technical processing data for booking modifications. There is a need for a tool which supports the process of booking modifications and reduces the time consumed on such processing while improving consistency and reducing subjectivity.

Accordingly, there is a need for an electronic device and a method for modifying booking data associated with a booking for a shipping system, which mitigate, alleviate or address the shortcomings existing and provide a more time efficient control of the processing of booking modification with an improved accuracy, robustness and consistency.

Disclosed is a method, performed by an electronic device, for modifying booking data associated with a booking for a shipping system. The method comprises obtaining a text data set. The method comprises determining, based on the text data set and an entity extraction model, a modification set comprising an entity parameter and a first modification parameter, wherein the first modification parameter is associated with a first confidence parameter. The method comprises outputting, based on the modification set, a modification output for modifying the booking.

Further, an electronic device is disclosed. The electronic device comprises memory circuitry, processor circuitry, and an interface. The electronic device is configured to perform any of the methods disclosed herein.

Disclosed is a computer readable storage medium storing one or more programs, the one or more programs comprising instructions, which when executed by an electronic device with a display and a touch-sensitive surface cause the electronic device to perform any of the methods disclosed herein.

It is an advantage of the present disclosure that the disclosed electronic device and method provide a more time efficient control of the processing for modifying booking data with improved accuracy, robustness and consistency. Advantageously, the disclosed electronic device and method provide high accuracy and wide extendibility for various scenarios. The disclosed technique may enable automation of booking modification of shipment bookings. The disclosed technique may eventually automate the process and minimize time to update a booking. The disclosed technique may lead to faster execution of a booking modification.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating schematically example representation of booking data according to this disclosure,

FIG. 2 is a diagram illustrating schematically a process where the disclosed technique is carried out by an example electronic device according to this disclosure,

FIG. 3 is a diagram illustrating schematically an example representation of an example entity extraction according to this disclosure,

FIG. 4 is a flow-chart illustrating an exemplary method, performed by an electronic device, for modifying booking data associated with a booking for a shipping system according to this disclosure, and

FIG. 5 is a block diagram illustrating an exemplary electronic device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

One or more exemplary methods disclose automated entity extraction, specifically for booking amendments. The method can receive a booking amendment directly from a user via an input, such as through an e-mail, computer input, pdf scan, a user defined note (UDN), etc. However, due to the nature of a user created input, the input may be difficult to interpret for a computer system, and thus a human interpreter may be needed. However, advantageously in one or more exemplary methods, the human interpreter may only be needed as a last resort and one or more of the disclosed methods may be able to properly read the input partially or in its entirety with a particular confidence. Thus, the method may be able to modify a booking via the input when there is a high confidence level of a given portion of the input. For low confidence levels, a human interpreter can be brought in by the method. This can greatly improve processing speeds, while maintaining high confidence in the booking amendments being made which are not reviewed by a human interpreter.

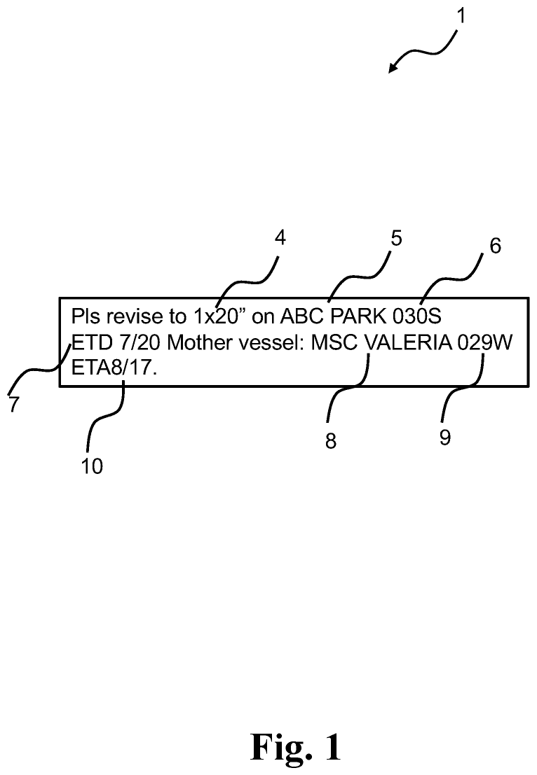

FIG. 1 shows a diagram illustrating schematically example representation 1 of booking data according to this disclosure. The representation 1 is for example a representation of a user defined note, UDN, which may be seen a modification request for a booking, e.g. provided by users for any booking related amendment. The UDN can be provided in any number of methods, such as but not limited to those discussed above.

Booking data may be obtained by the disclosed technique as a text data set. Booking data is indicative of a booking for a shipping system.

The representation 1 comprises a booking parameter 4 indicative of equipment associated with quantity, a booking parameter 5 indicative of a destination port, a booking parameter 6 indicative of voyage number for the vessel, a booking parameter 7 indicative of an estimated date of arrival, a booking parameter 8 indicative of name of the vessel, a booking parameter 9 indicative of a voyage number, and/or a booking parameter 10 indicative of a date for an estimated time of arrival.

A UDN may include one or more booking parameters indicative of one or more of: a release reference, a service mode, a Service contract, a load address, a Place of Receipt (PLR), a Release date, a load from time, a Destination (Port of Loading Destination, PLD), a Pickup depot, a Ventilation, a network access point, NAP, a Vessel, a Load Reference, an ETD, a load port, a Price Owner, an estimated time of arrival, ETA, a Discharge port, a Set Temperature, a generator set (e.g. which is required for reefer (air conditioned) container to supply power for cooling), Genset, a load from date, a humidity indicator, a Haulage instructions, a Confirmation email, Drains, Voyage, and a shipment identifier, SID. Other parameters can be used as well.

There may be one or more parameters illustrated in the representation 1 that are indicative of a modification value of the booking associated with the UDN illustrated by the representation 1. The present disclosure enable an extraction of an entity parameter, and a modification parameter, for example, in a pair from booking data of a booking for automated booking.

The modification parameter may be seen as a parameter used to modify, e.g., change, amend, booking data of a booking. The modification parameter may be extracted from a text data set indicative of the booking, and may be indicative of a modification value of one or more booking parameters, such as one or more booking parameters illustrated in representation 1.

The entity parameter may be seen as a parameter indicative of an element of the booking data, such as an element of the text data set. The entity parameter may be indicative of one or more booking parameters.

For example, there may be defined a number (such as 25, 30, 50, 200, 500 or more) mandatory entity parameter, which comes under booking modification scope.

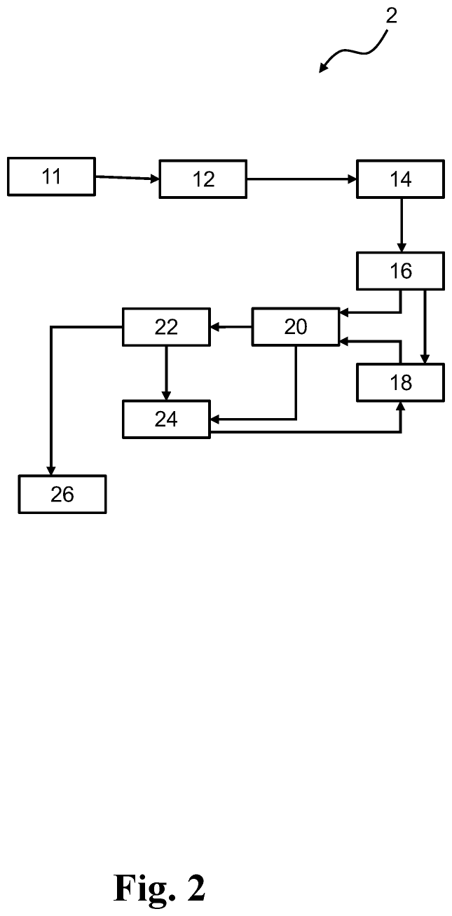

FIG. 2 shows a diagram illustrating schematically a process 2 where the disclosed technique is carried out by an example electronic device according to this disclosure.

Text data set 11 may be seen as un-structured data, e.g. based on request for booking modification, such as UDN. In one or more exemplary methods, the text data set 11 may include auditory and/or visual data which can be converted to a text data set. Text data set 11 may be fed into a step 12 related to a pre-processing step, such as text pre-processing technique. Any number of pre-processing steps can be performed. For example the step 12 may provide the text data with a reduced noise to a pattern identification 14. The step 14 provides one or more possible or potential pairs of entity parameter and modification parameter to a standardisation step 16 for standardizing and/or normalizing the one or more possible (e.g. pairs of) the entity parameter and the first modification parameter.

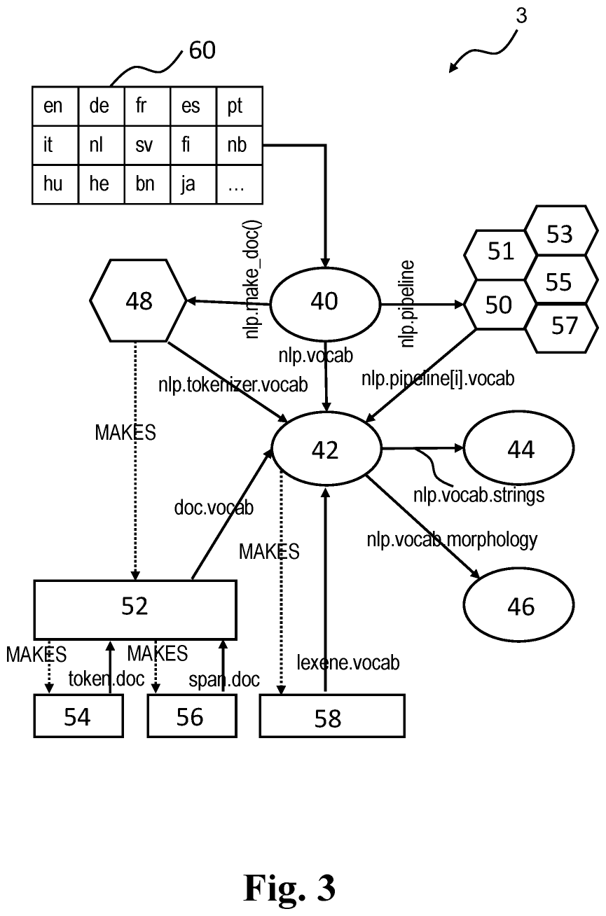

Step 16 provides standardized (e.g. pairs of) the entity parameter and the first modification parameter to an entity extraction model 20 (illustrated in FIG. 3) to determine an modification set comprising (e.g. pairs of) the entity parameter and the first modification parameter wherein the pair may be associated with a first confidence score. The entity extraction model 20 may receive a feedback input from a master pattern update 18 to improve the entity extraction model 20.

The entity extraction model 20 determines, based on the text data set, a modification set comprising an entity parameter and the first modification parameter, wherein the first modification parameter is associated with a first confidence score parameter.

The entity extraction model 20 may provide the modification set to a classifier step 22 that output, as extraction result 26, an entity parameter and a first modification parameter of the extraction set where the first confidence score satisfies a criterion, such as a high confidence score. The classifier step 22 may provide the extraction result 26 for modifying of the booking data.

Alternatively, the entity extraction model 20 may provide to the classifier step 22, the extraction result 26 comprising an entity parameter and a first modification parameter of the extraction set where the first confidence score satisfies a criterion, such as a high confidence score and may include in a fine-tuning data set 24 an entity parameter and a second modification parameter of the extraction set where the second confidence score does not satisfy the criterion, such as a low confidence score. The fine-tuning data set 24 may be passed on to the master pattern update 18 for fine tuning the entity extraction model.

The disclosed technique may be seen as enabling an automated modification of booking data e.g. for booking of a shipping system. For example, the disclosed technique may be seen as a machine learning enabled entity extraction required for booking modifications. The disclosed technique eliminates manual intervention which causes delay in determining the modification raised by customer.

The disclosed technique may use natural language processing (NLP) based entity extraction to get relevant booking modification related updates which can be streamlined to downstream application to complete the posting and reconciliation. NLP based extraction model provides intelligence with zero subjectivity to identify booking modifications which can be processed in fraction of time compared to manual route. The disclosed technique may eventually free-up resources dealing with a large amount of booking modifications and improve the processing which is also error prone and contains lot of subjectivity.

The disclosed technique may be seen as aiming as performing booking modification of shipment bookings. The disclosed technique may eventually automate the process and minimize time to update a booking. The disclosed technique may lead to faster execution of a booking modification.

The entity extraction model may use a booking corpus (e.g. UDNs) from different clusters and performs training to learn patterns associated with vital entities required for updating bookings.

FIG. 3 shows a diagram illustrating schematically an example representation 3 of an example entity extraction according to this disclosure.

The entity extraction model is configured to identify, based on a text data set 60, an entity parameter based on one or more patterns learnt by the entity extraction model. The entity extraction model is configured to extract an entity parameter and a respective modification parameter (such as modification value), which may be further sent for making booking amendment. Advantageously, the entity extraction model may be able to partially or fully interpret an original UDN to values having sufficient confidence.

The representation 3 of the entity extraction model comprises identifying 40 the language used in the text data set, a tokenizer 48 for tokenizing to make a document 52.

The representation 3 of the entity extraction model comprises elements for tagging such as one or more of: a tagger 50, a text categorizer 51, a custom component 53, a dependency parser 55, and an entity recognizer 57.

The representation 3 of the entity extraction model comprises a vocabulary 42 to make a lexeme 58, and optionally a document 52 to make a token 54, and/or a span 56. The representation 3 of the entity extraction model comprises a string store 44, an element 46 related to morphology (e.g. the internal structure of words), and a lexeme 58 (e.g. for lexical part of the language).

For example, with the UDN of FIG. 1, the extraction model may take the “1×20 inch” as input from the text data set, and identify that the language is English. The extraction model may use tokenizer 48 to divide a text into words.

The extraction model may use one or more elements of tagging (50, 51, 53, 55, 57) to determine if 20 inch is an equipment or something else: and to identify which category this text belongs to.

The extraction model may use the vocabulary 42 to identify one or more entity patterns. An entity pattern may be seen as a pattern exhibited by an entity.

The extraction model may use the document 52 to determine that the UDN requests to “revise to 1×20 inch” by checking the sequence of the words.

The extraction model may use the string store 44 and the morphology 46 to store the result.

The extraction model may provide a modification set including for example (entity, modification parameter, confidence score): (unit, 1, confidence score CS1), (equipment, inch, confidence score CS2), (destination, ABC PARK, confidence score CS3).

The text data set may provide unstructured text along with labeled entity value pair as input. The input after further data processing/standardization may be forwarded to tokenization and tagger. Based on tokenization and tagging information, the entity extraction model may learn the morphology structure from an inserted vocabulary to retain associative pattern for entity recognition. The process may be repeated over training instances and may retain considerable patterns based on associative strength. The extracted and/or learnt pattern may be utilized for extracting entities from future and/or test instances.

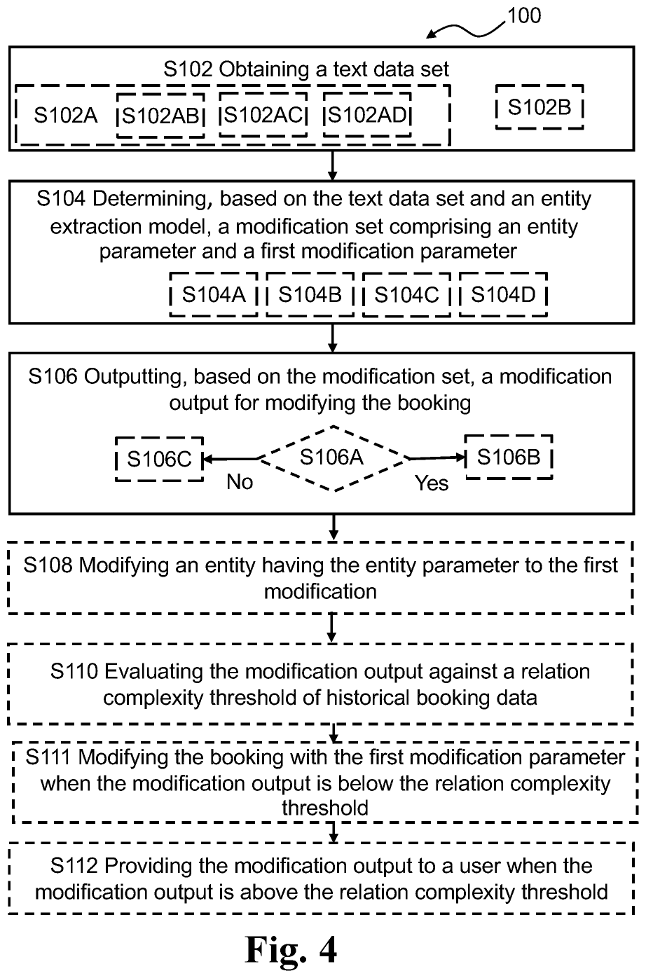

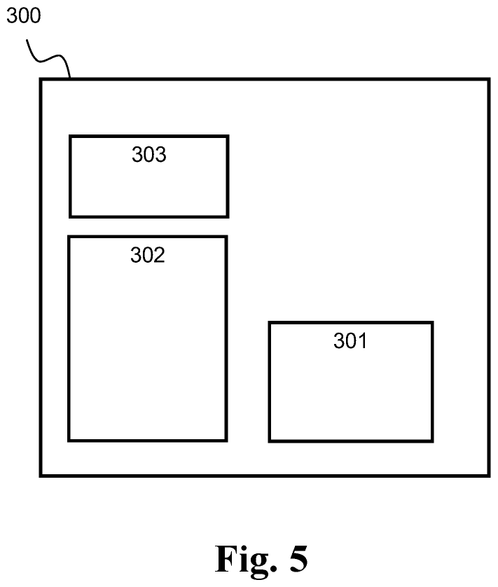

FIG. 4 shows a flowchart illustrating an example method 100, performed by an electronic device (such as the electronic device disclosed herein, such as electronic device 300 of FIG. 5), for modifying booking data associated with a booking for a shipping system. The method 100 comprises obtaining S102 a text data set. In one or more example methods, the text data set is indicative of booking data associated with a booking. In one or more example methods, the obtaining S102 comprises obtaining S102B a label, e.g. a text label (e.g. ‘equipment type’ or ‘equipment size’ etc.) associated with a corresponding element of the text data set.

In one or more example methods, the text data set is obtained from an un-structured text or unstructured data. For example, the un-structured data or un-structured text may be cleansed by reducing noise, normalized and/or transformed to feed into the entity extraction model.

In one or more example methods, the obtaining S102 comprises pre-processing S102A the un-structured text.

In one or more example methods, the pre-processing S102A comprises reducing S102AB noise in the un-structured text to obtain the text data set. In one or more example methods, noise in a data set may refer to corruption in the data set, such as additional meaningless or incorrect data elements. In one or more example methods, reducing S102AB noise in the invoice data set may comprise removing features identified as noisy. In one or more example methods, reducing S102AB noise in the invoice data set may comprise lowering down the importance of particular feature(s). For example, the noise in the invoice data set may be seen as cancelled, removed and/or suppressed.

In one or more example methods, the pre-processing S102A comprises normalizing S102AC the un-structured text to obtain the text data set In one or more example methods, normalizing S102AB a data set may refer to restricting the data set so that attributes of data elements of the data set are standardized to comply with one or more of the same representation “norms” or types. In one or more example methods, a normalization may be performed using scaling, and/or encoding.

In one or more example methods, the pre-processing S102A comprises transforming S102AD the un-structured text to obtain the text data set. The transformation may include one or more of: extracting words and/or arranging the words in sequential manner.

The method 100 comprises determining S104, based on the text data set and an entity extraction model, a modification set comprising an entity parameter and a first modification parameter. The first modification parameter is associated with a first confidence parameter. For example, the entity extraction model determines based on the text data set, the modification set comprising the entity parameter and a first modification parameter, and optionally a second modification parameter and optionally a third modification parameter, wherein the first modification parameter is associated with the first score parameter, and optionally the second modification is associated with a second score parameter, and optionally the third modification is associated with a third score parameter.

In one or more example methods, the determining S104 comprises performing S104D pattern identification of the un-structured text. Pattern identification may be based on training instances to provide robust and best-in-class accuracy model

In one or more example methods, the determining S104 comprises respective confidence scores, such as the first confidence score.

A confidence score may be seen as an indicator of the confidence of the association of the entity parameter with a certain modification parameter such as the first modification parameter.

For example, when the entity parameter is indicative of an equipment, this may be given based on the text data set, based on representation 1 of FIG. 1: a first modification parameter 20″ with a first score parameter 0.9, and optionally a second value 030S with a score parameter 0.2, because 030S appears in the UDN illustrated but does not have a property characteristic of an equipment.

In one or more example methods, the determining S104 comprises determining S104A a language of the text data set. For example, the language may be determined at initial stage before feeding to the entity extraction model.

In one or more example methods, the entity parameter is selected from a list of targeted entities.

In one or more example methods, the list of targeted entities includes one or more entities indicative of a vessel (such as vessel type, and/or vessel name), equipment, a voyage (such as load port, discharge port, voyage path, voyage length, and/or pick-up depot), a service (such as service contract and/or service mode) and/or an environment parameter (such as set temperature and/or humidity).

In one or more example methods, the entity extraction model comprises a Natural Language Processing, NLP, model.

In one or more example methods, the determining S104 comprises tokenizing S104B and/or applying S104C a tag to a corresponding element of the text data set based on the entity extraction model. Tokenization may be seen as a technique of separating a piece of text into smaller units called tokens. Here, tokens can be either words, characters, or subwords. Hence, tokenization can be classified into 3 types—word, character, and subword (n-gram characters) tokenization. For example, tokenization may break bigger pieces of text into its respective elements like single words (unigram), and/or two consecutive words (bi-gram).

The method 100 comprises outputting S106, based on the modification set, a modification output for modifying the booking. For example, the modification output may support concluding which entity indicated by the entity parameter has been requested for modification with associated modification parameter and confidence score. For example, the modification output may be evaluated against relation complexity with pattern evaluation (e.g. historical booking pattern). When the complexity is low, then auto trigger for booking amendment will be considered. For example, the disclosed electronic device is capable to take ‘unstructured text’ data from booking details to intelligently identify modification component and feed to complete automated booking modification.

In one or more example methods, the outputting S106 comprises determining S106A whether the first confidence parameter satisfies a criterion. A criterion may be selected to achieve high accuracy for the modification parameter. For example, the criterion may be based on a threshold above which the criterion is satisfied. For example, the threshold may be 0.7.

In one or more example methods, the outputting S106 comprises when it is determined that the first confidence score parameter satisfies the criterion, including S106B the entity parameter and the first modification parameter in the modification output.

In one or more example methods, the outputting S106 comprises when it is determined that the first confidence score parameter does not satisfy the criterion, including S106C the entity parameter associated with the first value parameter into a fine-tuning data set. Further, the outputting S106 can further send a request to a user interpreter for analysis.

In one or more example methods, the method 100 comprises modifying S108 an entity having the entity parameter to the first modification parameter. For example, modifying S108 an entity having the entity parameter to the first modification parameter may comprise modifying the entity having the entity parameter from an original parameter to the first modification parameter.

In one or more example methods, the method 100 comprises evaluating S110 the modification output against a relation complexity threshold of historical booking data.

In one or more example methods, the method 100 comprises modifying S111 the booking with the first modification parameter when the modification output is below the relation complexity threshold. In one or more example methods, the method 100 comprises providing S112 the modification output to a shipping system (e.g. to a user of a shipping system) when the modification output is above the relation complexity threshold (such as 0.9 for numeric entity values, and/or 0.7 for text entity values).

In one or more exemplary methods, the method 100 can further modify a booking based on the text data set originally received.

FIG. 5 shows a block diagram of an exemplary electronic device 300 according to the disclosure. The electronic device 300 comprises memory circuitry 301, processor circuitry 302, and an interface 303. The electronic device 300 is configured to perform any of the methods disclosed in FIG. 4. In other words, the electronic device 300 is configured for modifying a booking for a shipping system.

The interface 303 may be configured for wired and/or wireless communications.

The electronic device 300 is configured to obtain (such as via the interface 303, and/or the memory circuitry 301) a text data set. The electronic device 300 may be, for example, a computer, a laptop, a cellular phone, a tablet, and/or combinations thereof.

The electronic device 300 is configured to determine (e.g., via the processor circuitry 302), based on the text data set and an entity extraction model, a modification set comprising an entity parameter and a first modification parameter. The first modification parameter is associated with a first confidence parameter.

The electronic device 300 is configured to output (e.g. using the processor circuitry 302, and/or the interface 303), based on the modification set, a modification output for modifying the booking data.

The processor circuitry 302 is optionally configured to perform any of the operations disclosed in FIG. 4 (such as any one or more of: S102A, S102AB, S102AC, S102AD, S102B, S104A, S104B, S104C, S104D, S106A, S106B, S106C, S108, S111, S110, S112). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store one or more programs comprising instructions in a part of the memory.

The memory circuitry 301 may be configured to store information, such as information related to a booking, text data set, an entity extraction model, a modification set, an entity parameter, and/or a first modification parameter in a part of the memory.

Embodiments of methods and products (electronic device) according to the disclosure are set out in the following items:
Item 1. A method, performed by an electronic device, for modifying booking data associated with a booking for a shipping system, the method comprising:
   obtaining (S102) a text data set;
   determining (S104), based on the text data set and an entity extraction model, a modification set comprising an entity parameter and a first modification parameter, wherein the first modification parameter is associated with a first confidence parameter; and
   outputting (S106), based on the modification set, a modification output for modifying the booking data.
Item 2. The method according to item 1, wherein the obtaining (S102) comprises obtaining (S102B) a label associated with a corresponding element of the text data set.
Item 3. The method according to any of the previous items, the method comprising modifying (S108) an entity having the entity parameter to the first modification parameter.
Item 4. The method according to any of the previous items, wherein the text data set is obtained from an un-structured text.
Item 5. The method according to item 4, wherein the determining (S104) comprises performing (S104D) pattern identification of the un-structured text.
Item 6. The method according to any one of items 4-5, wherein the obtaining (S102) comprises pre-processing (S102A) the un-structured text.
Item 7. The method according to item 6, wherein the pre-processing (S102A) comprises reducing (S102AB) noise and/or normalizing (S102AC) and/or transforming (S102AD) the un-structured text to obtain the text data set.
Item 8. The method according to any of the previous items, the method comprising evaluating (S110) the modification output against a relation complexity threshold of historical booking data.
Item 9. The method according to item 8, the method comprising modifying (S111) the booking with the first modification parameter when the modification output is below the relation complexity threshold.
Item 10. The method according to item 8, the method comprising providing (S112) the modification output to a shipping system when the modification output is above the relation complexity threshold.
Item 11. The method according to any of the previous items, wherein the determining (S104) comprises determining (S104A) a language of the text data set.
Item 12. The method according to any of the previous items, wherein the entity parameter is selected from a list of targeted entities.
Item 13. The method according to item 12, wherein the list of targeted entities includes one or more entities indicative of a vessel, equipment, a voyage, a service and/or an environment parameter.
Item 14. The method according to any of the previous items, wherein the entity extraction model comprises a Natural Language Processing, NLP, model.
Item 15. The method according to any of the previous items, wherein the determining (S104) comprises tokenizing (S104B) and/or applying (S104C) a tag to a corresponding element of the text data set based on the entity extraction model.
Item 16. The method according to any of the previous items, the outputting (S106) comprising:
   determining (S106A) whether the first confidence parameter satisfies a criterion; and
   when it is determined that the first confidence score parameter does not satisfy the criterion, including (S106C) the entity parameter associated with the first value parameter into a fine-tuning data set.
Item 17. The method according to any one of items 1-15, the method comprising
   determining (S106A) whether the first confidence parameter satisfies a criterion; and
   when it is determined that the first confidence score parameter satisfies the criterion, including (S106B) the entity parameter and the first modification parameter in the modification output.
Item 18. An electronic device comprising memory circuitry, processor circuitry, and an interface, wherein the electronic device is configured to perform any of the methods according to any of items 1-17.
Item 19. A computer readable storage medium storing one or more programs, the one or more programs comprising instructions, which when executed by an electronic device causes the electronic device to perform any of the methods of items 1-17.

The use of the terms “first”, “second”, “third” and “fourth”, “primary”, “secondary”, “tertiary” etc. does not imply any particular order, but are included to identify individual elements.

Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-5 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by an electronic device, for modifying booking data associated with a booking for a shipping system, the method comprising:
obtaining a text data set;
determining, based on the text data set and an entity extraction model, a modification set comprising an entity parameter and a first modification parameter, wherein the first modification parameter is associated with a first confidence parameter; and
outputting, based on the modification set, a modification output for modifying the booking data.

2. The method according to claim 1, wherein the obtaining comprises obtaining a label associated with a corresponding element of the text data set.

3. The method according to claim 1, the method comprising modifying an entity having the entity parameter to the first modification parameter.

4. The method according to claim 1, wherein the text data set is obtained from an un-structured text.

5. The method according to claim 3, wherein the determining comprises performing pattern identification of the un-structured text.

6. The method according to claim 4, wherein the obtaining comprises pre-processing the un-structured text.

7. The method according to claim 6, wherein the pre-processing comprises reducing noise and/or normalizing and/or transforming the un-structured text to obtain the text data set.

8. The method according to claim 1, the method comprising evaluating the modification output against a relation complexity threshold of historical booking data.

9. The method according to claim 5, the method comprising modifying the booking with the first modification parameter when the modification output is below the relation complexity threshold.

10. The method according to claim 5, the method comprising providing the modification output to a shipping system when the modification output is above the relation complexity threshold.

11. The method according to claim 1, wherein the determining comprises determining a language of the text data set.

12. The method according to claim 1, wherein the entity parameter is selected from a list of targeted entities.

13. The method according to claim 12, wherein the list of targeted entities includes one or more entities indicative of a vessel, equipment, a voyage, a service and/or an environment parameter.

14. The method according to claim 1, wherein the entity extraction model comprises a Natural Language Processing, NLP, model.

15. The method according to claim 1, wherein the determining comprises tokenizing and/or applying a tag to a corresponding element of the text data set based on the entity extraction model.

16. The method according to claim 1, the outputting comprising:
determining whether the first confidence parameter satisfies a criterion; and
when it is determined that the first confidence score parameter does not satisfy the criterion, including the entity parameter associated with the first value parameter into a fine-tuning data set.

17. The method according to claim 1, the method comprising
determining whether the first confidence parameter satisfies a criterion; and
when it is determined that the first confidence score parameter satisfies the criterion, including the entity parameter and the first modification parameter in the modification output.

18. An electronic device comprising memory circuitry, processor circuitry, and an interface, wherein the electronic device is configured to perform any of the methods according to claim 1.

19. A computer readable storage medium storing one or more programs, the one or more programs comprising instructions, which when executed by an electronic device causes the electronic device to perform the method of claim 1.
